(19) United States
(12) Patent Application Publication
(10) Pub. No.: US 2004/0045175 A1
(43) Pub. Date: Mar. 11, 2004

(54) TREE PRUNER

(76) Inventor: Ming-Shan Jang, Taichung Hsien (TW)

Correspondence Address: Rabin & Berdo, P.C., Suite 500, 1101 14th Street, Washington, DC, 20005, US

(21) Appl. No.: 10/234,394

(22) Filed: Sep. 5, 2002

(51) Int. Cl. B26B 13/00

(52) U.S. Cl. 30/249; 30/246; 30/245; 30/296.1

(57) ABSTRACT

A tree pruner has a extension rod, a cutting set and a pull cord. The cutting set is mounted on the top end of the extension rod and has a stationary blade, a pivoting blade, an actuating lever and a pinion gear. The stationary blade is securely connected to the top end of the extension rod. The pivoting blade is pivotally attached to the stationary blade and has multiple driven teeth. The actuating lever is pivotally attached to the stationary blade and has multiple actuating teeth. The pinion gear is rotatably mounted on the stationary blade and engages the driven teeth on the pivoting blade and the actuating teeth on the actuating lever. Accordingly, the cutting set can easily cut off a tree branch, and the force applied to the pull cord is magnified at the blades of the tree pruner.

### BACKGROUND OF THE INVENTION

1. Field of the Invention

The present invention relates to a tree pruner, and more particularly to a tree pruner that can prune a tree easily and the energy loss during the operation of the tree pruner is minimized.

2. Description of Related Art

A tree pruner with a rod is usually used to cut off dead or living branches of a tree low on the tree but out of reach of the person pruning the tree. With reference to FIG. 6, a conventional tree pruner in accordance with the prior art comprises an extension rod (80), a cutting head and a pull cord (70). The extension rod (80) has a top end and bottom end. The cutting head is attached to the top end of the extension rod (80) and comprises a stationary blade (93), a pivoting blade (94) and an actuating lever (95). The stationary blade (93) has a leg (91) with a holder (90) attached to the top end of the extension rod (80). The pivoting blade (94) is pivotally attached and corresponds to the stationary blade (93) so the stationary blade (93) and the pivoting blade (94) cut with a scissors action. The actuating lever (95) is pivotally connected to the pivoting blade (94) with a pivot pin (not numbered). A slot (not numbered) is defined in the actuating lever (95) through which the pivot pin slidably extends. A spring (96) is connected between the stationary blade (93) and the actuating lever (95). The pull cord (70) is threaded through pulleys (97) on the actuating lever (95) and the extension rod (80). When the cord (70) is pulled, the pivoting blade (94) will pivot relative to the stationary blade (93) to cut off a branch by means of the transmission of the actuating lever (95). The pivoting blade (94) will return to the original position with the tension provided by the spring (96) when the user releases the pull cord (70).

However, during the operation of the conventional pruner, the actuating lever (95) will slide relative to the pivoting blade (94) along the slot until the pivot pin reaches the end of the slot before pulling on the pivoting blade (94). Because the actuating lever (95) and the pivoting blade (94) are not locked together, the actuating lever (95) will continue to pivot downward as the pull cord (70) is pulled with only a small downward force applied to the end of the pivoting blade (94). Consequently, the pivoting blade (94) will not be able to cut larger branches until the actuating lever (95) is pulled to a nearly perpendicular position relative to the pivoting blade (94). Even in a nearly perpendicular position, a large force must be applied to the pull cord (70) to cut a tree branch with a large diameter. The only mechanical advantage achieved by the conventional pruner is the mechanical advantage achieved through the set of pulleys. The cutting effect of the conventional tree pruner is not consistent throughout the range of movement of the actuating lever (95), and the ability of the conventional tree pruner to cut large branches is not good enough.

To overcome the shortcomings, the present invention tends to provide a tree pruner to mitigate or obviate the aforementioned problems.

### SUMMARY OF THE INVENTION

The main objective of the invention is to provide a tree pruner that can easily cut off a tree branch and the energy applied is consistent throughout the range of operation of the tree pruner. The tree pruner has an extension rod, a cutting set and a pull cord. The extension rod has a top end and a bottom end. The cutting set is mounted on the top end of the extension rod and has a stationary blade, a pivoting blade, an actuating lever, a pinion gear, a spring and pull cord assembly. The stationary blade is securely attached to the top end of the extension rod. The pivoting blade is pivotally attached to the stationary blade and has multiple driven gear teeth formed on an arcuate edge of the stationary blade. The actuating lever is pivotally attached to the stationary blade and has a proximal end, a distal end and multiple actuating gear teeth formed on the proximal end of the actuating lever. The pinion gear is rotatably mounted on the stationary blade and simultaneously engages the driven gear teeth on the pivoting blade and the actuating gear teeth on the actuating lever. At least one upper pulley is rotatably attached to the distal end of the actuating lever. At least one lower pulley is rotatably attached to the extension rod. A pull cord is threaded through the upper pulleys and the lower pulleys. Accordingly, the cutting set can easily cut off a tree branch. The movement of the pivoting blade is directly proportional to the movement of the actuating lever. The meshing of the driven gear teeth, the actuating gear teeth and the pinion gear cause the force applied to the distal end of the actuating lever to be magnified at the pivoting blade. The mechanical advantage of the gears allows the pruner to be able to cut tree branches more easily.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a cutting set for a tree pruner in accordance with the present invention;

FIG. 2 is an exploded perspective view of the cutting set in FIG. 1;

FIG. 3 is a side plan view of the stationary blade of the tree pruner in FIG. 1;

FIG. 4 is a side plan view in partial cross section of the tree pruner in accordance with the present invention;

FIG. 5 is an operational side plan view in partial section of the tree pruner in FIG. 1 showing the pivoting blade rotated by means of the gear set driven by the actuating lever when the pull cord is pulled; and

FIG. 6 is a side plan view of a conventional tree pruner in accordance with the prior art.

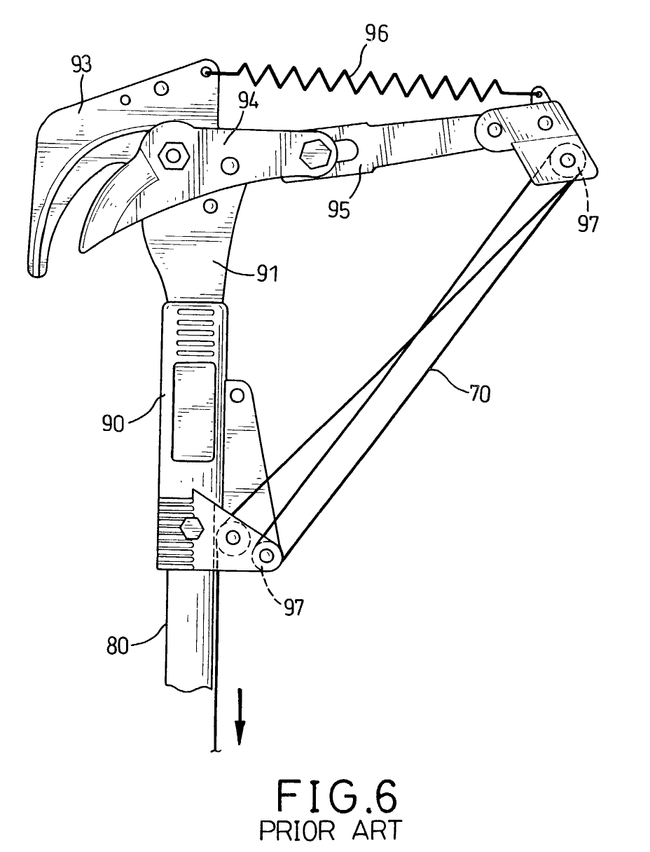

### DETAILED DESCRIPTION OF PREFERRED EMBODIMENT

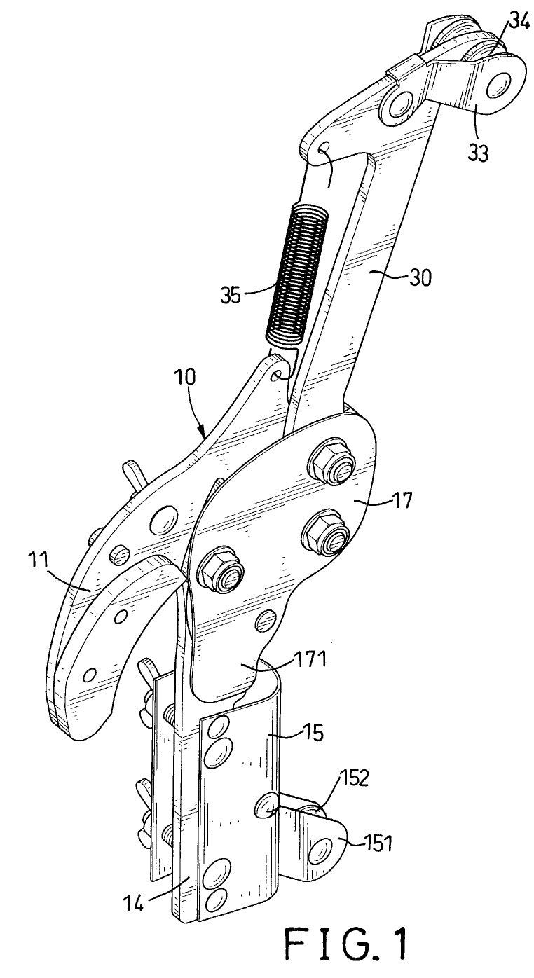

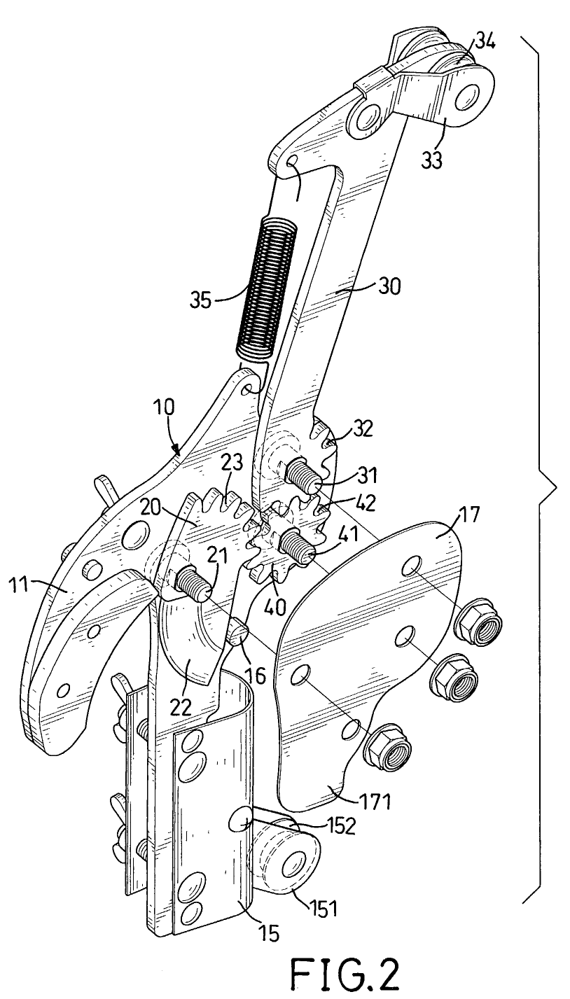

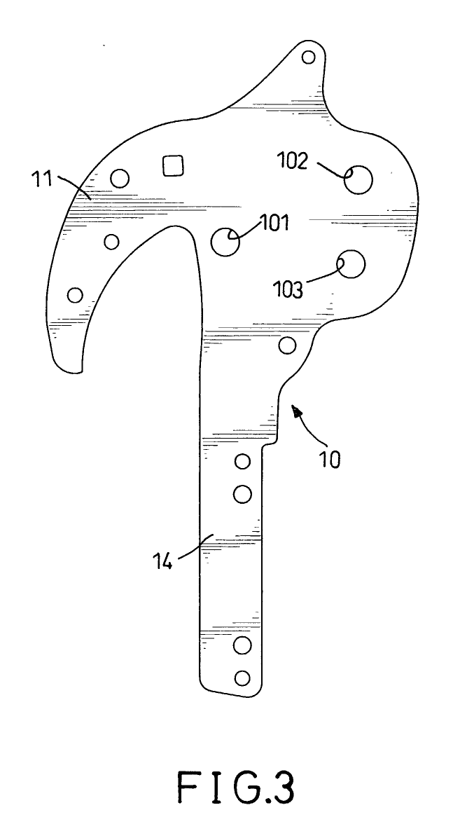

With reference to FIGS. 1 to 4, a tree pruner in accordance with the present invention comprises an extension rod (not numbered), a cutting set and a pull cord (70). The extension rod has a top end and a bottom end (not shown). The cutting set is attached to the top end of the extension rod. The cutting set comprises a stationary blade (10), a pivoting blade (20), an actuating lever (30), a pinion gear (40), a spring (35), a cover (17) and a pull cord assembly.

The stationary blade (20) is securely attached to the top end of the extension rod. In practice, the stationary blade (10) has a top, a bottom, a front edge, a back edge, a blade (11), a central pivot hole (101), an actuating lever pivot hole (102), a pinion gear pivot hole (103), a limit stub (16), a leg (14) and a rod holder (15). The limit stub (16) is mounted near the back edge of the stationary blade (10) below the central pivot hole (101) and the pinion gear pivot hole (103). The leg (14) integrally extends from the bottom of the stationary blade (10). The holder (15) has a U-shaped cross section, is securely attached to the leg (14) and securely encloses the top end of the extension rod.

The pivoting blade (20) has a front edge, a rear edge, a blade (12) and driven teeth (23) and is pivotally attached to the stationary blade (10) with a first pivot pin (21) mounted through the central pivot hole (101) in the stationary blade (10). The blade (22) is on the front edge of the pivoting blade (20) and corresponds to the blade (11) on the stationary blade (10). The two blades (11, 22) cut with a scissor action. The rear edge of the pivoting blade (20) is curved with a relatively large radius of curvature when compared to the pinion gear (40). The driven teeth (23) are formed on the curved rear edge of the pivoting blade (20).

The actuating lever (30) has a proximal end, a distal end, a top edge, a bottom edge and multiple actuating gear teeth (32). The proximal end has a curved edge and is pivotally attached to the stationary blade (10) near the rear edge of the stationary blade (10). A second pivot pin (31) passes through the actuating lever pivot hole (102) and the proximal end of the actuating lever (30) to pivotally attach the actuating lever (30) to the stationary blade (10). The actuating teeth (32) are formed on the curved edge of the proximal end of the actuating lever (30). The curved edge has a radius of curvature essentially equal to the pinion gear.

The spring (35) has two ends and is connected between the top of the stationary blade (10) and the distal end of the actuating lever (30) to apply a restitution force to the actuating lever (30).

The pinion gear (40) is rotatably mounted on the stationary blade (10) with a third pivot pin (41) that passes through the pinion gear pivot hole (103). The pinion gear (40) is circular with an outer edge and a radius essentially equal to the radius of curvature of the actuating teeth (32) and smaller than the radius of curvature of the driven teeth (23). Multiple pinion teeth (42) are formed on the outer edge of the pinion gear (40) and simultaneously engage the driven teeth (23) on the pivoting blade (20) and the actuating teeth (32) on the actuating lever (30).

The pull cord assembly comprises an upper pulley assembly, a lower pulley (152) and a pull cord (70). The upper pulley assembly comprises two pulleys (34) rotatably mounted in an upper pulley bracket (33) attached to the distal end of the actuating lever (30). The lower pulley (152) in rotatably mounted in a lower pulley bracket (151) that is firmly attached to the holder (15). The pull cord (70) is mounted around the lower pulley (152) and the upper pulleys (34) on the actuating lever (30). The pull cord (30) has a first end secured to the holder (15) and a second end extending to the bottom end of the extension rod.

The cover (17) is securely attached to the stationary blade (10) to cover the pivoting blade (20), the pinion gear (40) and the actuating teeth (32) on the actuating lever (30). In practice, the three pivot pins (21, 31, 41) are bolts. The bolts extend through the cover (17), and three nuts (not numbered) are respectively screwed onto the bolts to securely attach the cover (17) to the stationary blade (10). The cover (17) keeps foreign objects from jamming the gear teeth (23, 32, 42) on the pivoting blade (20), the actuating lever (30) and the pinion gear (40). This ensures the smooth of the operation of the tree pruner. The limit stub (16) is mounted on the stationary blade (10) to limit the movement of the pivoting blade (20).

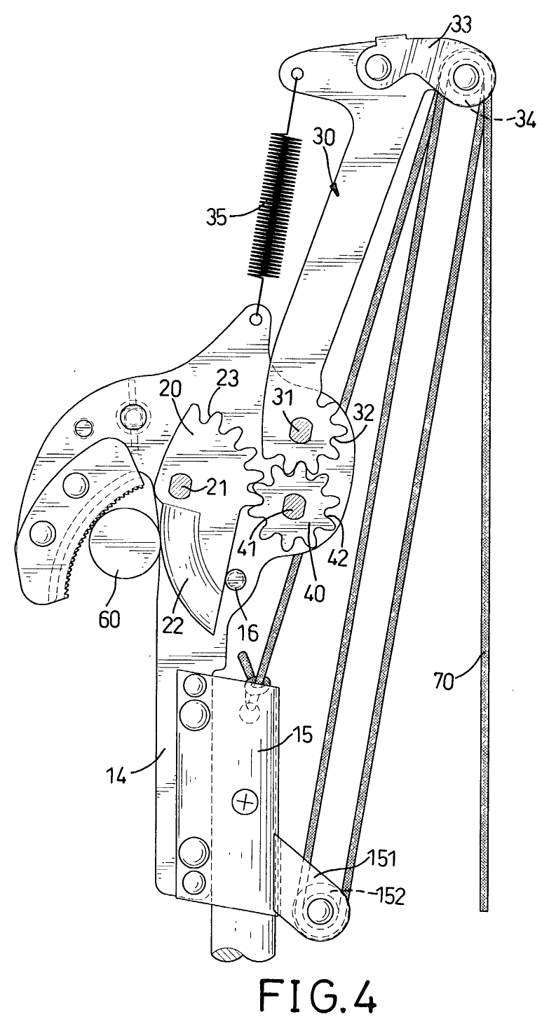

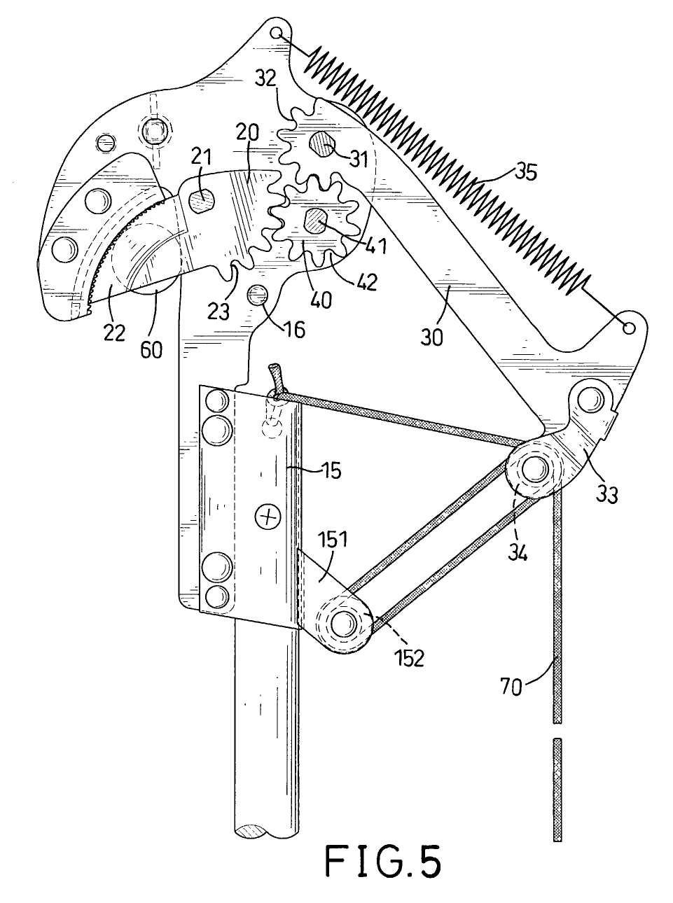

With reference to FIGS. 4 and 5, the actuating lever (30) will be forced to move downward when a user pulls the pull cord (70) downward. The engagement between the teeth (32, 42) on the actuating lever (30) and the pinion gear (40) cause the pinion gear (40) to be rotated when the actuating lever (30) is moved down. The engagement between the pinion teeth (42) and the driven teeth (23) cause the pivoting blade (22) to pivot relative to the stationary blade (20), such that an object (60) between the blades (11, 22) will be cut.

When the pull cord (70) is released, the actuating lever (30) and the pivoting blade (20) will be rotated to the original position as the spring (35) pulls the distal end of the actuating lever (30) back to an upright position. The stub (16) stops the pivoting blade (20).

In such a tree pruner, the actuating lever (30) is directly linked to the pivoting blade (20) so no slippage occurs when the pull cord (70) is pulled. Accordingly, the force applied to the pruned object (60) by the pivoting blade (20) and the stationary blade (10) is greater than the force applied to the pull cord (70), such that the user can easily prune an object (60) with a large diameter.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tree pruner comprising:
an extension rod having a top end and a bottom end;
a pull cord with two ends; and
a cutting set comprising;
a stationary blade securely connected to the top end of the extension rod and having a top, a bottom, a front edge, a back edge, and a blade formed on the front edge of the stationary blade;
a pivoting blade pivotally attached to the stationary blade and having a front edge, a rear edge, a blade corresponding to the blade of the stationary blade and multiple driven teeth formed on the rear edge of the pivoting blade;
an actuating lever has a proximal end, a distal end, a top edge, a bottom edge and multiple actuating gear teeth, where the proximal end is pivotally attached to the stationary blade, and the actuating teeth are formed on the proximal end of the actuating lever;
a pinion gear rotatably mounted on the stationary blade and having pinion teeth formed on an outer edge of the pinion gear and simultaneously engaging the driven teeth on the pivoting blade and the actuating teeth on the actuating lever;
a spring connected between top of the stationary blade and distal end of the actuating lever; and
a pulley assembly comprising:
an upper pulley assembly with at least one upper pulley rotatably connected to the distal end of the actuating lever; and
at least one lower pulley rotatably connected to the stationary blade,
where the pull cord is threaded through the at least one upper pulley and the at least one lower pulley with one end securely connected to the stationary blade and the other end extending to the bottom end of the extension rod.

2. The tree pruner as claimed in claim 1, wherein the stationary blade has a leg integrally extending from the bottom of the stationary blade; and
a rod holder is securely attached to the leg and securely encloses the top end of the extension rod,
wherein one end of the pull cord is securely attached to the rod holder.

3. The tree pruner as claimed in claim 2 further comprising a lower pulley bracket firmly attached to the holder for the at least one lower pulley rotatably mounted on the pulley standbracket.

4. The tree pruner as claimed in claim 1 further comprising an upper pulley bracket securely attached to the distal end of the actuating level for the at least one upper pulley rotatably mounted on the upper pulley standbracket.

5. The tree pruner as claimed in claim 1, wherein the cutting set further comprises a cover securely attached to the stationary blade to cover the pivoting blade, the pinion gear and the actuating teeth on the actuating lever.

6. The tree pruner as claimed in claim 1 further comprising a limit stub mounted on the stationary blade to limit movement of the pivoting blade.
